(19) United States
(12) Patent Application Publication
(10) Pub. No.: US 2009/0052167 A1
(43) Pub. Date: Feb. 26, 2009

(54) LUMINOUS CLOTHING ACCESSORY AND LUMINOUS CLOTHING FIBER AND LUMINOUS ACCESSORIZED CLOTHES USING THEM

(76) Inventor: Taduko Ono, Tochigi (JP)

Correspondence Address: ROTHWELL, FIGG, ERNST & MANBECK, P.C., 1425 K STREET, N.W., SUITE 800, WASHINGTON, DC, 20005, US

(21) Appl. No.: 12/279,675

(22) PCT Filed: Nov. 10, 2005
(86) PCT No.: PCT/JP2005/020643

§ 371 Date: Oct. 30, 2008

(30) Foreign Application Priority Data
Oct. 18, 2005 (JP) 2005-302466

(51) Int. Cl. F21V 21/08

(52) U.S. Cl. 362/103

(57) ABSTRACT

To provide luminescent accessories, a luminescent clothing fiber and luminescent clothing using those, which exhibit originality to freely demonstrate individual characteristics by each wearer without sticking to a design of clothing itself, and which enable the differentiation from other clothing.

[The present invention] is luminescent accessories to be attached to clothing, such as Western clothes, a kimono or an obi, and has a structure comprising an attachment part, a power source and a luminous object connected to the power source. Further, [the present invention] is a fiber to be woven into clothing fibers, such as Western clothes, a kimono or an obi, that comprises an optical fiber, and that has a structure where at least one or more light escaping parts are established at predetermined sections of the optical fiber. It is possible to create any variety of luminescent clothing from these luminescent accessories and luminescent fibers. As the luminous object, a light-emitting diode may be used or it can adopt a structure that changes a luminous pattern of the luminous object.

### TECHNICAL FIELD

The present invention relates to accessories for a dress attached to clothing, such as Western clothes, a kimono or an obi, or clothing fibers woven into said clothing.

### BACKGROUND TECHNOLOGY

People have usually worn clothing, and it is essential for living. However, they wear the clothing not only for living but also for dressing up themselves as fashion these days. Then, in order to dress up themselves, they try to personalize themselves by wearing something different from other people. However, there must be many people who have felt awkward because of seeing other people wear the same clothing. In other words, it is almost impossible to try to purchase clothing no one else has, and it is the actual situation that absolute original means only clothing of hand-made goods.

Then, clothing, which can be worn inside out, generally referred to as ‘reversible’ is variously proposed. According to these proposals, if a design, such as a pattern, is differentiated between a right side and a reverse side, it becomes possible to mix-and-match two different versions with one wardrobe. However, only two versions are still monotonous, and after all, people end up wearing only the favorite design side, and if the clothing is the same reversible one as others', there is also a risk to wear the clothing with the same design in 50% of the situations.

Further, clothing presenting various appearances by attaching detachable members to the clothing, such as detachment or combination of the members, is also proposed. For example, there is a wardrobe whose sleeves can be detached from the shoulders or the intermediate sections of the sleeves. According to this proposal, although it is true that this is convenient as a wardrobe used both in summer and winter, there is hardly a difference from the aspect of fashion, and the above-mentioned problems have not been solved yet. Further, there is also clothing that is designed to have a detachable decorative member, such as an emblem, and whose decorative members can be variously changed at the time of wearing. According to this proposal, a change of the decorative members brings some degrees of change; however, as similar to the above-mentioned clothing, there is hardly a difference in the aspect of fashion and the above-mentioned problems have not been solved yet [with this concept].
Patent Literature 1: Japanese Patent Application Laid-Open No. 2004-183202
Patent Literature 2: Japanese Patent Application Laid-Open No. 2002-247110
Patent Literature 3: Japanese Patent Application Laid-Open No. 2001-55610
Patent Literature 4: Japanese Patent Application Laid-Open No. 2000-234207
Patent Literature 5: Japanese Utility-Model Application Laid-Open No. H1-165879
Patent Literature 6: Japanese Utility-Model Application Laid-Open No. S63-123613
Patent Literature 7: Japanese Utility-Model Application Laid-Open No. S61-159309

### DISCLOSURE OF THE INVENTION

### Problem to be Solved by the Invention

Taking the problems into consideration, the objective of the present invention is to provide luminescent accessories, luminescent clothing fibers and luminescent clothing using these accessories and/or fibers that have originality enabling demonstration of free individual characteristics by each individual, and enable realization of discrimination from other clothing.

### Means for Solving the Problem

In order to accomplish the objective, the present invention is accessories for a dress that are attachable to clothing, such as Western clothes, a kimono or an obi, and that are luminescent accessories composed of an attaching part, a power source, and a luminous object connected to the power source, respectively.

Further, the present invention is a luminescent clothing accessory by using the luminescent accessories as a clothing accessory.

In addition, the present invention is luminescent clothing by attaching the luminescent accessories to any sections of the clothing.

In addition, the present invention is a fiber to be woven into the fibers of clothing, such as Western clothes, a kimono or an obi, and formed with optical fibers, and is a luminescent clothing fiber where at least one or more light escaping parts exist in predetermined sections of the optical fiber.

In addition, the present invention is clothing that is woven with the luminescent clothing fibers, and it is equipped with at least one or more power sources at predetermined sections; concurrently, at least one or more luminous objects, and where lights of the luminous objects are transmitted by the optical fibers and escaped from the light escaping parts.

Further, the present invention can adopt a mode where the luminescent clothing is a kimono or an obi.

In addition, the present invention can adopt a configuration where the luminous object is a light-emitting diode.

In addition, the present invention is equipped with a circuit, and can adopt a configuration where a luminous pattern of the luminous object is changed.

### Efficacy of the Invention

With the luminescent accessories relating to the present invention, it is possible to easily attach them by sewing, and the clothing where the accessories are attached enables creation that is rich in originality with an excellent aesthetic sense, like clothing where beads and/or spangles are stitched or that is trimmed with embroidery.

Further, according to the luminescent accessories and the luminescent clothing fibers relating to the present invention, the decorative effect referred to as luminescence provides an innovative aesthetic sense of clothing, and if a person wears clothing where the luminescent accessories are optionally attached, such as Western clothes, a kimono or an obi, or clothing where the luminescent accessories are used as buttons, or clothing where the luminescent clothing fibers are used, the differentiation from other clothing is accomplished and the clothing that excels in the decorative properties having sufficient originality can be provided.

In addition, a change in a luminous pattern of the luminous objects by establishing a circuit results in a change in the luminous pattern, such as a color emitted by the luminous objects, strength of luminosity or blinking, and a further excellent decorative effect is provided; concurrently, originality is demonstrated by each individual wearer and it enables subjective and objective differentiation.

### BEST MODE FOR CARRYING OUT THE INVENTION

Hereafter, embodiments of the luminescent accessories relating to the present invention will be described based upon drawings.

FIG. 1 is a cross sectional view showing luminescent accessories 1 relating to the present invention. The luminescent accessories 1 are composed of an attaching part 2, a power source 3, and a luminous object 4 connected to the power source 3.

The attaching part 2 is for enabling easy attachment of the luminescent accessories 1 to clothing, and its structure is not particularly limited, but as shown in FIG. 1 or FIG. 2 (a), the attaching part 2 can be needle threading holes for attaching, or as shown in FIG. 2 (b), it can be a safety pin. Further, for the power source 3, it shall not be particularly limited as long as it demonstrates a function as a power source, but it is desirable that the luminescent accessories 1 relating to the present invention is small-sized from a functional point of view; therefore, it is desirable to adopt a small-sized one, such as a button cell. Then, in order to have the freely-replaceable power source 3, an opening/closing mechanism, such as a hinge 6 or screw as shown in the drawing, is established.

The luminous object 4 is connected to the power source 3 and shall emit a light by receiving a power source supply from the power source 3. The luminous object 4 is not particularly limited, and a light bulb or a light-emitting diode can be considered. If taking miniaturization or power consumption into consideration, the light-emitting diode is desirable. Further, it is desirable to have a structure where the power supply from the power source part can be arbitrarily turned ON/OFF by establishing a switch 7 as shown in the drawing. Furthermore, in the drawing, a cover 5 for covering the upper side of the luminous object 4 is attached; however, it is not always necessary to have said structure. The cover 5 functions as a protective cover in the case that the luminous object 4 is a light bulb or functions to change a luminescent color to be emitted by changing a color of the cover 5.

Further, as shown in the drawing, another mode to change a luminous pattern of the luminous object 4 by establishing a substrate 8 and a circuit 9 between the power source 3 and the luminous object 4 can also be considered. In other words, this is a mode where a power supply from the power source 3 to the luminous object 4 is changed by an instruction from the substrate 8 and the circuit 9, and the luminescent accessories 1 can blink or increase/decrease a light or the luminescent color can be changed when the luminous object 4 is composed of multiple light-emitting diodes with different colors.

As a use mode of the luminescent accessories 1 relating to the present invention configured as described above, various use modes, such as a use as a button for clothing, can be considered. FIG. 3 and FIG. 4 show use modes where the luminescent accessories 1 are attached to arbitrary sections, and FIG. 3 shows a use mode of Western clothes, FIG. 4 (a) shows a use mode of an obi and FIG. 4 (b) shows a use mode of a kimono. There is no particular limitation in the attaching mode, such as sections to be attached or the number of accessories for a dress to be attached, and it is possible to attach them at random or by patterning a certain figure, such a star sign, as shown in FIG. 4 (b). Furthermore, it is needless to say, there is no particular limitation about clothing, which is a subject for having the accessories attached, and anything, such as scarf, gloves, shawl, veil, hat, turban or other ethnic costume, can be a subject other than the Western clothes and kimonos shown in the drawings.

As described above, the luminescent accessories 1 relating to the present invention enables free attachment and detachment to/from clothing, and if a wearer feels bored with the design by the attached luminescent accessories 1, it is also possible to easily change to another design. Furthermore, a mode where attachment & detachment of the luminescent accessories 1 is disabled but the luminescent accessories 1 providing a predetermined pattern to the clothing in advance are secured and luminescent clothing W can be considered.

FIG. 5 is a cross sectional view showing a luminescent clothing fiber 10 relating to the present invention. The luminescent clothing fiber 10 is formed with an optical fiber 11, and it is configured by establishing at least one or more light escaping parts 12 at predetermined sections of the optical fiber 11.

In the optical fiber 11, since a characteristic of a light to attempt to travel through a section with a high refractive index is utilized, a phenomenon referred to as total reflection where lights within a certain incident angle are all reflected into glass occurs. This is a phenomenon to occur due to a difference in refractive indexes. However, the establishment of the light escaping part 12 whose refractive index is partially high in the inside of the optical fiber 11 a causes an escape of a portion of light from the inside of the optical fiber 11a.

FIG. 6 shows a use mode in the case of using the related luminescent clothing fibers 10 as fibers of the luminescent clothing W. A plurality of the light escaping parts 12 are established in predetermined sections of luminescent clothing fiber 10, and the luminescent clothing W is configured by weaving these as fibers for clothing or weaving them into fibers for clothing. At this time, the luminescent clothing W shall be equipped with at least one or more power sources 3 arranged at the predetermined sections; concurrently, equipped with at least one or more luminous objects 4 connected to the power sources 3. Then, lights from the luminous objects 4 transmit through the inside of the optical fiber 11a and are escaped from the light escaping parts 12.

Furthermore, for the power source 3, it is not particularly limited as long as the one demonstrates a function as a power source as similar to the luminescent accessories 1, and a small size is preferable from the viewpoint of function; therefore, it is desirable to adopt a small-sized power source 3, such as a button cell.

The luminous object 4 is connected to the power source 3 as similar to the luminescent accessories 1 and emits a light by receiving a power supply from the power source. The luminous object 4 is not particularly limited, and a light bulb or a light-emitting diode can be considered, and taking the miniaturization and power consumption into consideration, a light-emitting diode is preferable.

For a luminous pattern, as shown in the drawings, a mode changing the luminous pattern of the luminous object 4 by establishing the substrate 8 and the circuit 9 between the power source 3 and the luminous object 4 can be considered. In other words, this is a mode where the power supply attached from the power source 3 to the luminous object 4 is changed by instructions from the substrate 8 and the circuit 9, and the luminescent accessories 1 can blink, or increase & decrease a light or when the luminous objects 4 are multiple light-emitting diodes with different colors, it is possible to change a luminous color. Further, another mode where a color, blinking and light decrease & increase are closely changed by establishing different luminous object 4, power source 3, substrate 8 and circuit 9 per fiber, and the decorative effect of the luminescent clothing W is also possible.

Other that those, it is similar to the luminescent accessories 1 that the power source 3 by an opening/closing mechanism, such as a hinge, is freely exchangeable and it is desirable to establish the ON/OFF mechanism of the power supply by a switch.

As described above, since it is unnecessary for the luminescent clothing W using the luminescent clothing fibers 10 to place a power source at each luminescent section, the exchange of the power source is easy and the luminescent clothing W becomes lightweight, it is no such thing that a person feels uncomfortable to wear.

### INDUSTRIAL APPLICABILITY

As described above, since the luminescent accessories 1, the luminescent clothing fiber 10 and the luminescent clothing W created by attaching or weaving these relating to the present invention enable provision of glitter and vivid colors in an outfit requiring gorgeousness, such as furisode, ceremonial kimono or a party dress, will contribute to the development of new category in the clothing industry; concurrently, will historically vault the conventional clothing industry. Further, in the costume field of stage art, for example, if an opera singer or ballet dancer performs with a costume created from the luminescent accessories 1 or the luminescent clothing fibers 10, new art creation can be realizable, for example, the person's expression can strongly and beautifully impress upon the audience. In addition, if is used for a school bag or clothing for a child, his/her presence at night can be confirmed, and a use mode where while the fashion characteristics is taken into consideration, it demonstrates an effect as an accident avoidance is also possible.

### BRIEF DESCRIPTION OF DRAWINGS

FIG. 1 is a cross sectional view showing a luminescent accessory relating to the present invention.

FIG. 2 is an explanatory diagram showing an embodiment of the attachment part of the luminescent accessories relating to the present invention.

FIG. 3 is an explanatory diagram showing a use mode of the luminescent accessories relating to the present invention.

FIG. 4 is an explanatory diagram showing a use mode of the luminescent accessories relating to the present invention.

FIG. 5 is a cross sectional view showing a luminescent clothing fiber relating to the present invention.

FIG. 6 is an explanatory diagram showing a use mode of the luminescent clothing fiber relating to the present invention.

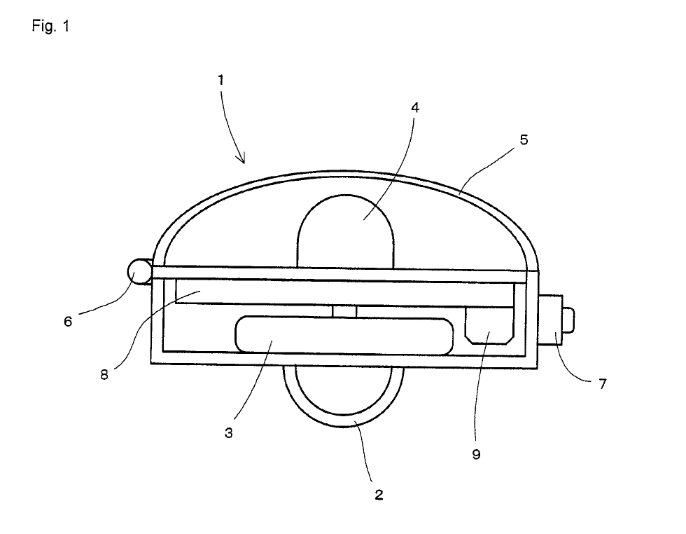

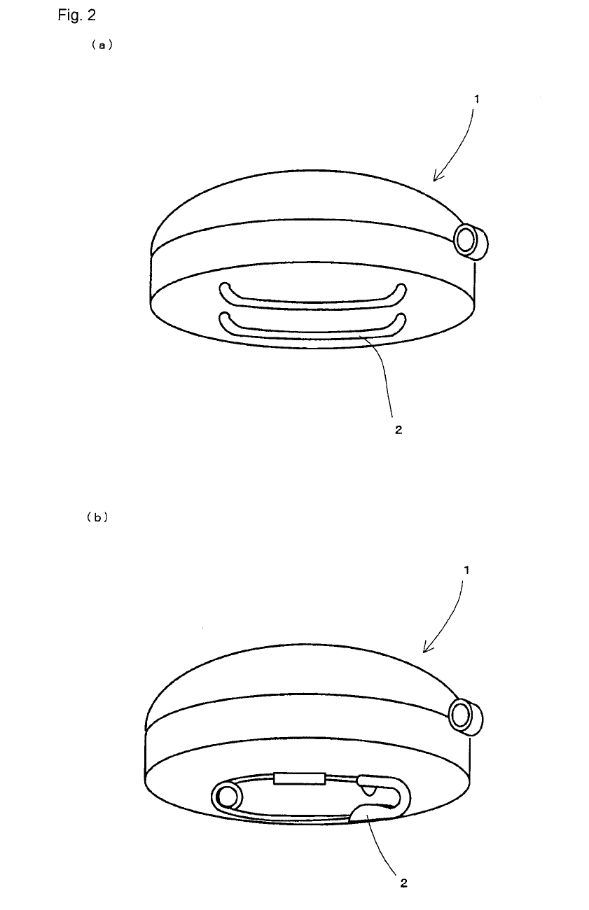

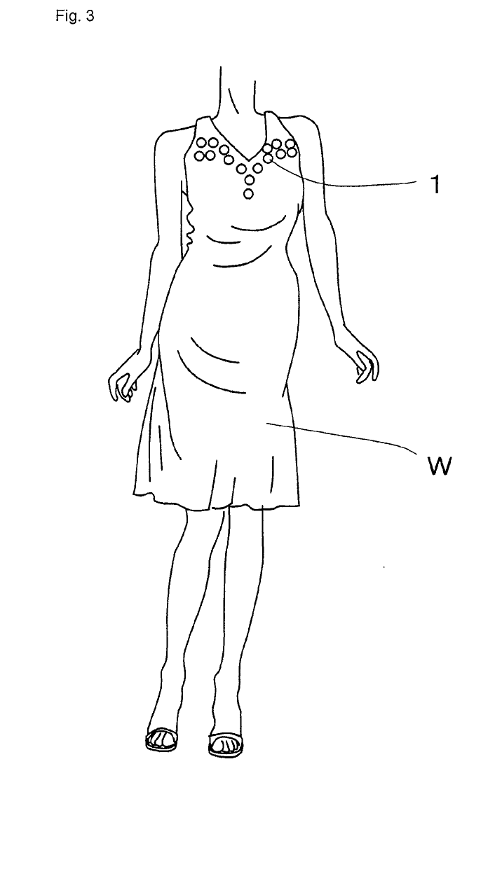

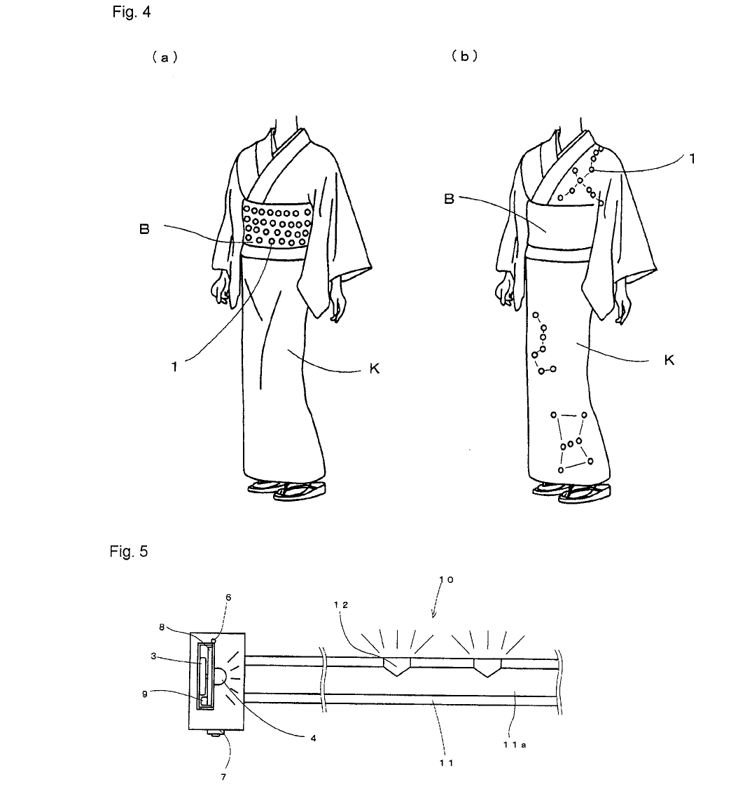

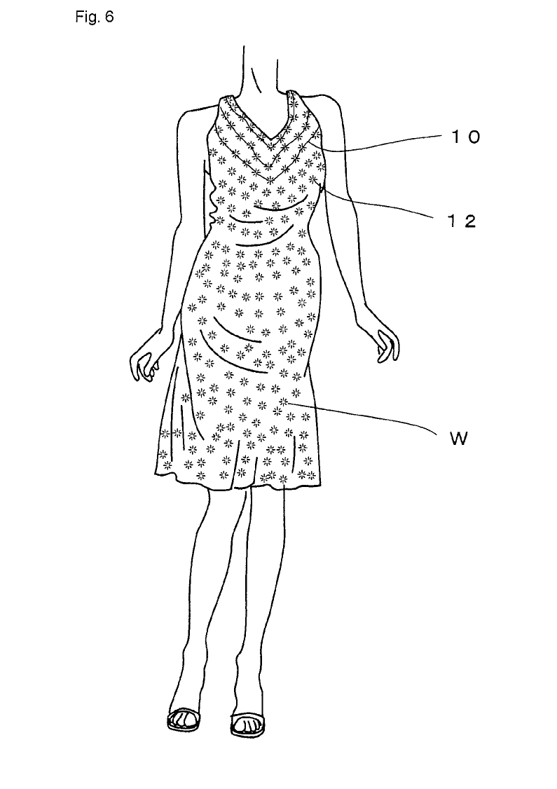

### DESCRIPTION OF SYMBOLS

1 luminescent accessory
2 attachment part
3 power source
4 luminous object
5 cover
6 hinge
7 switch
8 substrate
9 circuit
10 luminescent clothing fiber
11 optical fiber
11a inside of optical fiber
12 light escaping part
   B luminescent clothing obi
   K luminescent clothing kimono
   W luminescent clothing

What is claimed is:

1. Luminescent accessories to be attached to clothing, such as Western clothes, a kimono or an obi, comprising an attachment part, a power source, and a luminous object connected to the power source.

2. The luminescent accessories according to claim 1, wherein the luminous object is a light-emitting diode.

3. The luminescent accessories according to claim 1 or claim 2, wherein, a circuit is arranged in the luminescent accessories and a luminous pattern of the luminous object is changed.

4. A clothing accessory button, wherein the luminescent accessory is a button for clothing.

5. Luminescent clothing, wherein the luminescent accessories are attached at arbitrary sections.

6. A luminescent fiber to be woven into clothing fibers, such as Western clothes, a kimono or an obi, comprising an optical fiber, wherein at least one or more light escaping parts are established at predetermined sections of the optical fiber.

7. Luminescent clothing woven with the luminescent clothing fibers comprising one or more power sources at predetermined sections; concurrently, comprising at least one or more luminous objects connected to the power sources, wherein lights of the luminous objects are transmitted by the optical fibers and the lights are escaped from the light escaping parts.

8. The luminescent clothing according claim 7, wherein the luminous object is a light-emitting diode.

9. The luminescent clothing according to claim 7 or claim 8, wherein a circuit is established in the luminescent clothing and a luminous pattern of the luminous object is changed.

10. The luminescent clothing according to any of claim 5, and claim 7 to claim 9, wherein the luminescent clothing is a kimono.

11. The luminescent clothing according to any of claim 5, and claim 7 to claim 9, wherein the luminescent clothing is an obi.
